(19) United States
(12) Patent Application Publication
(10) Pub. No.: US 2009/0190101 A1
(43) Pub. Date: Jul. 30, 2009

(54) Double-Reverse Total-Internal-Reflection-Prism Optical Engine

(75) Inventors: Ilkka A. Alasaarela, Oulunsalo (FI); Jussi P. Soukkamaki, Oulu (FI)

Correspondence Address: HARRINGTON & SMITH, PC, 4 RESEARCH DRIVE, Suite 202, SHELTON, CT, 06484-6212, US

(73) Assignee: International Business Machines Corporation

(21) Appl. No.: 12/361,064

(22) Filed: Jan. 28, 2009

Related U.S. Application Data
(60) Provisional application No. 61/062,626, filed on Jan. 28, 2008.

(51) Int. Cl. G03B 21/28

(52) U.S. Cl. 353/81

(57) ABSTRACT

A device for a light projection system comprises at least one light source; light collection and relay optics; a reflective surface; a micro-display; an illumination total internal reflection TIR-prism disposed between the reflective surface and the micro-display; an imaging TIR-prism disposed between the illumination TIR-prism and the micro-display; and a projection lens. The light collection and relay optics is arranged to channel light emitted by the at least one light source to the illumination TIR-prism. The TIR-prism is arranged to totally internally reflect the light to the reflective surface. The reflective surface is arranged to reflect the light back through the illumination TIR-prism and through the imaging TIR-prism to the micro-display. The micro-display is arranged to reflect the light back through the imaging TIR-prism. The imaging TIR-prism is arranged to totally internally reflect the light from the micro-display to the projection lens.

### CROSS REFERENCE TO RELATED APPLICATION

This application claims priority to U.S. Provisional Application Ser. No. 61/062,626, filed on Jan. 28, 2008 and entitled “Double Reverse Total-Internal-Reflection Prism (DR-TIR)—Optical Engine Configuration”, the contents of which are incorporated by reference herein in its entirety including Exhibit A attached thereto.

### TECHNICAL FIELD

The teachings herein relate generally to optical engines for projectors, and particularly an optical engine configuration for (light emitting diode) LED-illuminated (digital light projection) DLP-projectors.

### BACKGROUND

In last years, the digital revolution has increased the need for various kinds of digital display devices. Data-projectors have become widely available for different applications from consumer products to special applications such as head-up displays etc. One trend is towards smaller and smaller projectors with high lumen output. There is need for integrating projectors into various hand-held devices such as cameras or cellular-phones for example. On the other hand, in typical-sized projectors, such as data-projectors used in meeting rooms or home use, the constant need is to have high lumen output with small lamp power. Still, another need is for solutions which enable the use of LED (light emitting diode) as a light source for data projectors such as the lumen output and lumen/Watt-ratio are in the desired level. A common factor for these needs is the problem how to make a projector optical engine such that it enables small size and high throughput at the same time.

Data-projectors can be built by using micro-display technologies such as LCD (liquid crystal device), LCoS (liquid crystal on silicon), or DMD (digital micro-mirror device). DMD has great advantage over the liquid crystal based devices because one DMD panel can utilize the both linear polarization directions of the illuminating beam whereas liquid crystal based panels can modulate only one polarization per panel.

A disadvantage of DMD is the diagonally oriented mirror tilt axis. The panel needs to be illuminated from a diagonal direction, which will result in a difficult form factor and therefore larger size for the whole projection system package. Commonly used optical engine configurations with DMD micro-displays are the V-configuration, the field-lens configuration, the TIR-prism (total internal reflection-prism) configuration and the reverse-TIR-prism configuration. V-configuration typically addresses the diagonal illumination problem by using a fold mirror next to the imaging beam, which separates the illumination beam from the imaging beam, and orients the illumination beam horizontal direction. However, F-number is severely limited in V-configuration, which makes it unsuitable in many applications. The field lens configuration improves the V-configuration by inserting a field lens above the DMD panel such that the usable throughput can be improved. However, it uses high-refractive index high-NA (numerical aperture) field lens, which is expensive and causes aberrations, which together with the shadowing fold-mirror restricts the usable throughput. TIR-prism configuration has relatively large size, and the throughput is limited due to longer optical path between the DMD panel and the closest relay lens. It does not address the diagonal illumination problem in an effective way either. Therefore it is not a practical configuration in many applications. Reverse-TIR-prism configuration uses TIR-prism inverse direction in comparison to the TIR-prism configuration. Reverse-TIR-prism configuration typically addresses the diagonal illumination problem by using a wedge prism which tilts the illumination beam horizontal. Reverse-TIR-configuration enables small size, but the throughput is restricted due to non-desired TIR-reflections or prism-transmission. The operation of the reverse-TIR-configuration is described for example in International Patent Publication WO/2007/002694.

The above mentioned solutions for the diagonal illumination problem are capable of bending the illumination beam optical axis to the same plane with the imaging side optical axis, and therefore enable smaller size in one dimension (which is typically thickness of the projector).

### SUMMARY

According to an exemplary embodiment of the invention there is a device for a light projection system, the device comprising:
at least one light source;
light collection and relay optics;
a reflective surface;
a micro-display;
an illumination total internal reflection TIR-prism disposed between the reflective surface and the micro-display;
an imaging TIR-prism disposed between the illumination TIR-prism and the micro-display; and
a projection lens.
   In this embodiment the light collection and relay optics is arranged to channel light emitted by the at least one light source to the illumination TIR-prism; the TIR-prism is arranged to totally internally reflect the light to the reflective surface; the reflective surface is arranged to reflect the light back through the illumination TIR-prism and through the imaging TIR-prism to the micro-display; the micro-display is arranged to reflect the light back through the imaging TIR-prism; and the imaging TIR-prism is arranged to totally internally reflect the light from the micro-display to the projection lens.

Further objects and advantages will become apparent from a consideration of the ensuing description and drawings.

### BRIEF DESCRIPTION OF THE DRAWINGS

FIG. 1: schematic diagram of an optical engine according to an exemplary embodiment of the invention.

FIG. 2A: Upper view of an RTIR-optical engine configuration.

FIG. 2B: Upper view of an exemplary embodiment of the invention.

FIG. 2C: Side view of an RTIR-optical engine configuration.

FIG. 2D: Side view of an exemplary embodiment of the invention.

FIG. 3: A cosine-space representation of operation of an RTIR-optical engine configuration.

FIG. 4: A prism configuration according to an RTIR-optical engine configuration.

FIG. 5: A prism configuration according to an exemplary embodiment of the invention.

FIG. 6: A cosine-space representation of operation of an exemplary embodiment of the invention.

FIG. 7: Schematic diagram with three ray paths of an optical engine according to an exemplary embodiment of the invention.

FIGS. 8A-8B: An exemplary embodiment of the invention where relay optical system is integrated with the illumination TIR-prism.

FIGS. 9A-9B: An exemplary embodiment of the invention where the TIR-surface of the illumination TIR-prism is not parallel with the TIR-surface of the imaging TIR-prism.

FIGS. 10A-10B: An exemplary embodiment of the invention where the normals of the TIR-surfaces are on the same plane with diagonals of the micro-mirrors.

FIG. 11: An exemplary embodiment of the invention where a fly's eye lens array is used for homogenization of the beam.

FIG. 12A: A schematic diagram of an arrangement with three different color LED sources and three illumination modules with outputs combined by crossed dichroics according to an exemplary embodiment of the invention.

FIG. 12B: A schematic diagram like FIG. 12A but with one or more high-NA lenses or lens systems instead of the illumination modules according to an exemplary embodiment of the invention.

FIG. 12C: A schematic diagram like FIG. 12A but with a tapered light pipe together with a relay lens or relay lens systems instead of the illumination modules according to an exemplary embodiment of the invention.

FIG. 12D: A schematic diagram like FIG. 12A but with a TIR-collimator together with a fly's eye lens array and/or relay lenses are used instead of the illumination modules according to an exemplary embodiment of the invention.

FIG. 12E: A schematic diagram further adapting FIGS. 12A-12D.

FIGS. 13A-13E: schematic diagrams of various implementations of the mirror coated surface of FIG. 1 according to various embodiments of the invention.

FIGS. 14A-C: Schematic diagrams of various dispositions of the mirror coated second surface of the illumination TIR-prism according to various embodiment of the invention.

FIG. 15: A schematic diagram showing nomenclature of the prism surface normals.

FIG. 16: A schematic diagram showing nomenclature of the prism surface normals.

FIG. 17: A schematic embodiment of the invention comprising a field lens close to the micro-display according to an exemplary embodiment of the invention.

FIG. 18: A schematic exemplary embodiment of the invention comprising a prism between the illumination TIR-prism and the imaging TIR-prism.

FIGS. 19-21: Ray tracing result of the configuration in FIG. 8A.

FIGS. 22-24: Ray tracing result of the configuration in FIG. 10A.

### DETAILED DESCRIPTION

Embodiments of this invention provide a compact and efficient optical engine configuration for projectors, and are particularly advantageous for LED-illuminated DLP-projectors. One of the most advantageous existing configurations is the so-called reverse-TIR (total internal reflection) configuration used in some (digital light projector) DLP-projectors. The reverse-TIR configuration is a compact and efficient projector configuration, however it has a severe drawback resulting from the diagonal tilt direction of the DMD (digital micro-mirror device) panels: the panel needs to be illuminated from a diagonal direction, which will result in a difficult form factor and therefore larger size for the whole projection system package. An existing partial solution for that problem is to use a so-called wedge prism, which turns the illumination direction to the same plane with the imaging side optical axis, and therefore enables a smaller size in one dimension (which is typically the thickness of the projector).

Embodiments of this invention provide a new optical engine configuration which does not have that problem, and therefore enables the illumination direction to be not only at the same plane with the imaging axis, but also to have the illumination axis to be substantially parallel with the projection lens axis. This enables a small size for the projector in two dimensions (thickness and width for example) with high lumen throughput.

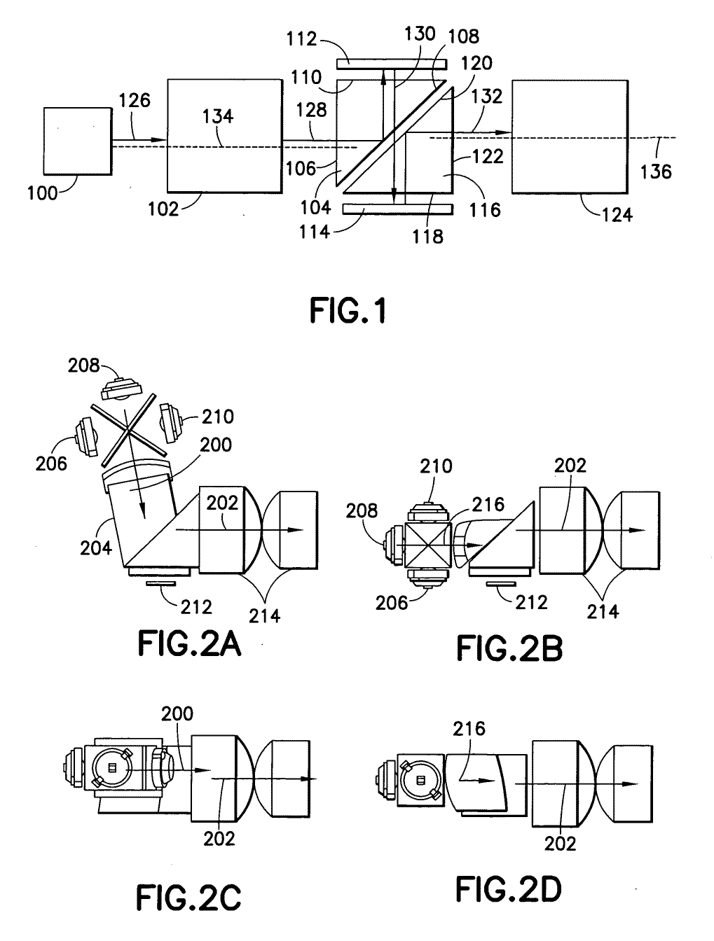

Following are described some embodiments of the invention with reference to the figures. FIG. 1 presents a generalized diagram of an exemplary embodiment of the invention. The optical engine comprises:
one or more light sources 100
collection and relay optical system 102
the illumination TIR-prism 104, which contains a first surface 106, an illuminating TIR-surface 108, and the second surface 110
the mirror 112
micro-display 114
the imaging TIR-prism 116, which contains a first surface 118, an imaging TIR-surface 120, and the second surface 122
a projection lens 124

Exemplary embodiments of the invention provide a new optical engine configuration which solves the diagonal illumination problem, enabling the illumination direction to be not only at the same plane with the imaging axis, but also to have illumination axis to be substantially co-directional with the projection lens axis, and so enabling small size for the projector in two dimensions (thickness and width for example).

One advantage of certain embodiments of the invention is a compact and efficient optical engine configuration for projectors, LED-illuminated DMD-projectors in particular. Accordingly, several technical effects of certain optical engine embodiments of the invention are:
Very compact size
Advantageous form factor
Large throughput
High optical efficiency
Small amount of optical components
Mass-manufacturable

The operation is the following: the light is emitted from the one or more light source(s) 100. The collection and relay optical system 102 collects the light from the light source(s) 100 and forms a substantially uniform illumination to the micro-display 114 through the illumination and imaging TIR-prisms 104,116. The light path is presented by the arrows 126, 128, 130, 132 accordingly. The illumination TIR-prism 104 reflects the beam 128 from the illuminating TIR-surface 108 by the use of total-internal reflection to the mirror 112, which further reflects the beam through the same illumination TIR-prism 104 and the illuminating TIR-surface 108 and through the imaging TIR-prism 116 and through its imaging TIR-surface 120 to the micro-display 114 as shown by arrow 130. The micro-display 114 reflects the beam from the desired pixels through the imaging TIR-prism 116 to the entrance pupil of the projection lens 124 as presented by the arrow 132. The imaging TIR-prism 116 reflects the beam 132 by the use of total-internal reflection at the imaging TIR-surface 120 from the micro-display 114 to the projection lens 124 entrance pupil.

Some of the novel key aspects of exemplary embodiments of the invention in comparison to the prior art is the illumination TIR-prism component, and the use of total-internal-reflection there. As can be seen schematically from FIG. 1 and in more detail in figures later, the use of the presented illumination TIR-prism component turns the illumination side optical axis, shown by the dashed line 134, substantially parallel with the imaging side optical axis, shown by the dashed line 136. The illumination side and the imaging side may be considered to be separated by the TIR surfaces 108, 120 (or the air gap between them).

In view of the arrows of FIG. 1 showing the optical axis through the overall device, it is seen that the optical axis of the device is parallel as between an input to the illumination TIR-prism where the light enters (at surface 106) from the at least one light source and an output of the imaging TIR-prism (at surface 122) where the light is directed toward the projection lens. The optical axis is a straight line from the output of the imaging TIR-prism through the projection lens. The device is arranged such that a beam of the light reflected from the micro-display 114 toward the imaging TIR-prism 116 is substantially telecentric. In the specific embodiment of FIG. 1 it can be seen that the illumination TIR-prism 104 is arranged to reflect the light from the light source (input at surface 106) at an angle of approximately ninety degrees toward the reflective surface (output from the illumination TIR-prism at surface 110), and the imaging TIR-prism is arranged to reflect the light from the micro-display (input at surface 118) at an angle of approximately ninety degrees toward the projection lens (output from the imaging TIR-prism at surface 122); and further that each of the reflective surface (of the mirror 112) and the micro-display 114 are arranged to reflect the light at an angle of approximately one hundred and eighty degrees. Typically DMD panels need to be illuminated from diagonal direction due to the tilt axis which is at a 45 degree angle with the pixel edges. The capability of having substantially parallel illumination and imaging side optical axis enables a smaller optical engine configuration. The smaller size which embodiments of the invention enable leads to another important advantage in commercial products: the possibility to increase system throughput without compromising the size which is described in the following:

The size and form factor advantage can be seen by comparing FIG. 2A and FIG. 2B to each other. FIG. 2A shows a micro-projection engine according to reverse-TIR optical engine configuration. The illumination optical axis vector 200 is turned into the same plane with the imaging side optical axis vector 202 by using a wedge prism 204. FIG. 2B shows a projection engine according the teachings of the invention with the same light sources 206, 208, 210, the same DMD panel 212, and the same projection lens 214 than FIG. 2A. The illumination optical axis vector 216 is not only on the same plane with the imaging side optical axis vector 202 but is (substantially) parallel with it, and therefore the size of the optical engine is substantially reduced. The form of the whole optical engine of FIG. 2B is easier to integrate inside other products, too, such as digital cameras for example. FIG. 2C and FIG. 2D show both engines from side view.

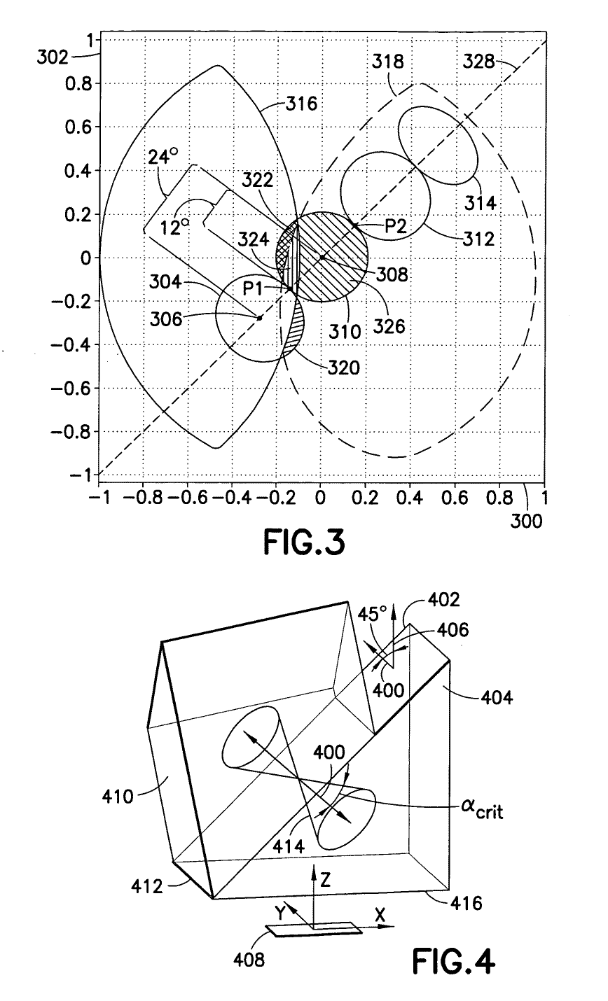

The operation of an optical engine of a projector can be presented in direction cosine space on the micro-display as shown in FIG. 3. The x-axis 300 and y-axis 302 are the x- and y-components of direction vectors accordingly. This kind of presentation is particularly useful when the illumination is telecentric, or close to telecentric. In non-telecentric systems this presentation can be used, too, but for each field-point separately. FIG. 3 shows a typical cosine space presentation of a reverse-TIR-prism optical engine. The corresponding prism configuration is shown in FIG. 4. Ellipse 304 encircles the incident illumination beam to the DMD-array. In this example, the tilt-angle of the micro-mirror is +/−12 degrees in pixel diagonal direction. Therefore the optical axis 306 of the incident beam 304 is oriented diagonally and in approximately 24 degree angle to the DMD-array normal, which is at the origin 308. The illumination beam has F/2.4 angular extent. The micro-mirrors are tilted −12 degrees diagonally towards point P1 in the on-state. Accordingly the circle 310 presents the output beam after reflection from the micro-mirrors. It presents the projection lens entrance pupil as well. The ellipse 312 shows the flat-state beam when micro-mirrors are not tilted at all. The ellipse 314 shows the off-state beam, when micro-mirrors are tilted +12 degrees diagonally towards point P2.

In a typical reverse-TIR-configuration the surface normal 400 of the TIR-surface 402 of the imaging TIR-prism 404 has 45 degree angle with the normal 406 of the DMD panel 408. Typically the closest wedge prism 410 surface 412 is parallel with the TIR-surface 402. Typical material for both prisms 404,410 is BK7, whose refractive index is approximately 1.52.

In order for the illumination beam to pass the air gap between the wedge prism 410 and the TIR-prism 404, the illuminating light needs to be oriented within the cone 414 span by the critical angle α_{crit} from the TIR-surface normal 400. The critical angle α_{crit} can be calculated by α_{crit}=α sin (n_{media}/nₚᵣᵢₛₘ), where nₚᵣᵢₛₘ=prism index of refraction and n_{media}=gap media index of refraction (in this example air). In order for the imaging beam to reflect from the TIR-surface 402 to the projection lens entrance pupil, the direction rays of the imaging beam need to be outside the same cone 414. Because the cone 414 presents the directions of the rays which are propagating inside the prisms, it can not be directly transferred to FIG. 3. The cone 414 need to be first ray traced through the first surface 416 of the TIR-prism 404 so that the rays propagate in air, after which the cone-curve can be drawn to FIG. 3. The ray traced part of the cone is represented by the curve 316. A part of the cone 414 can not be ray traced to the DMD due to total-internal-reflection at the first surface 416. That TIR-reflection can be seen from the curve 316 so that it is limited by an origin-centred circle with radius one, which is natural. The horizontally painted area 320 inside the illumination beam 304 lies outside the curve 316 and therefore can not pass the air gap from the wedge prism 410 to the TIR-prism 404. The curve 318 represents the curve 316 after reflection from the micro-mirrors at the on-state. Therefore the horizontally painted area 322 inside the imaging beam 310 is not illuminated. The vertically painted area 324 inside the imaging beam 310 is not reflected from the TIR-surface 402 because it is inside the curve 316. Only the diagonally painted area 326 inside the F/2.4 imaging beam 310 can be used in light projection, i.e. the etendue of the beam is restricted by the TIR-prism transmission cone 414.

The curve 316 is symmetric with respect to the x-axis. In order to eliminate the etendue restrictions 322,324 from the TIR-prism transmission cone 414, the cone should be arranged so that the corresponding curve 316 would be symmetric in respect to the diagonal line 328. In addition to that, the curve 316 should cross the diagonal line 328 at P1. That way the throughput limitations 322,324 due to the TIR-cone 414 would be eliminated. In order to achieve that, the prisms need to be rotated 45 degrees around the z-axis. In reverse-TIR-optical engine the z-rotation would cause the optical engine size to increase noticeably, especially the thickness of the projector (which is one of the most important features of projectors) would be increased substantially.

The invention brings solution to this problem, too. Because the whole optical engine is substantially linear in its shape, the diagonally oriented (i.e. rotated 45 degrees around z-axis) TIR-prism does not increase the engine size substantially, and small thickness of the projector can be preserved at the same time when the etendue restrictions are eliminated.

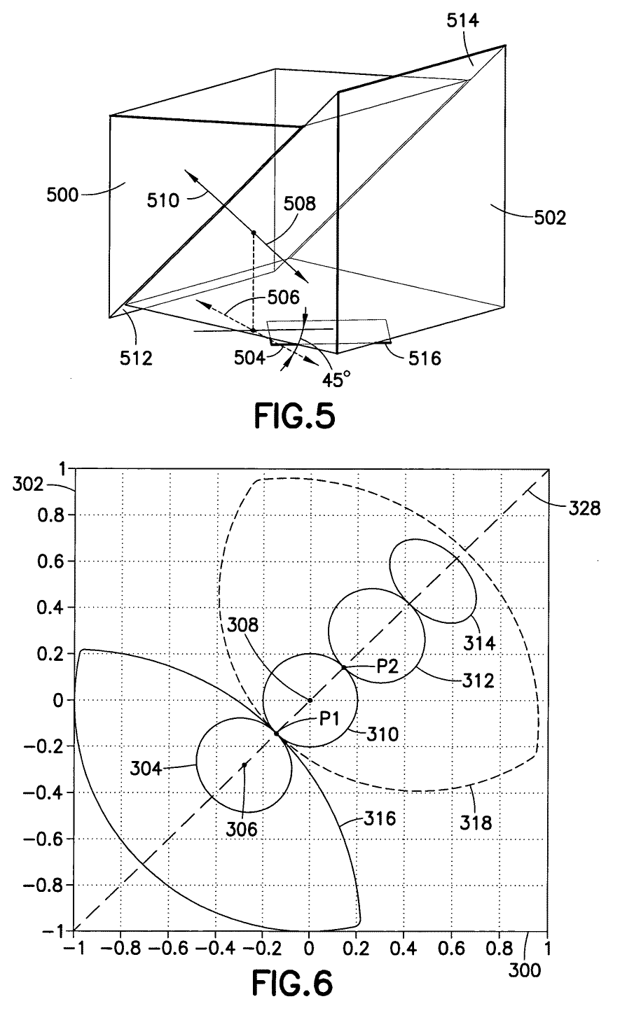

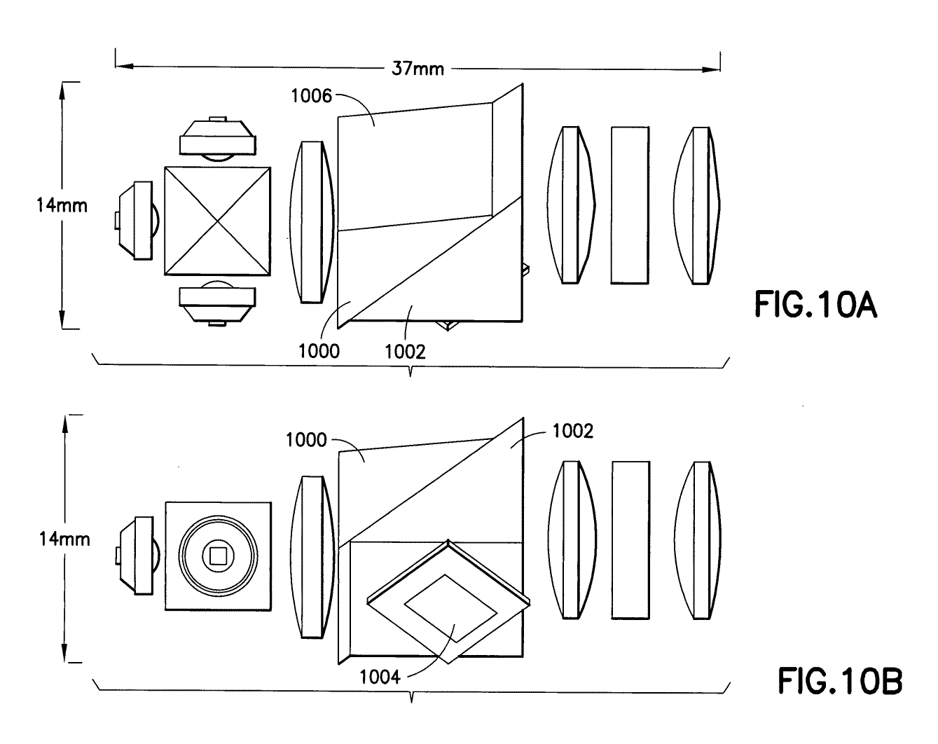

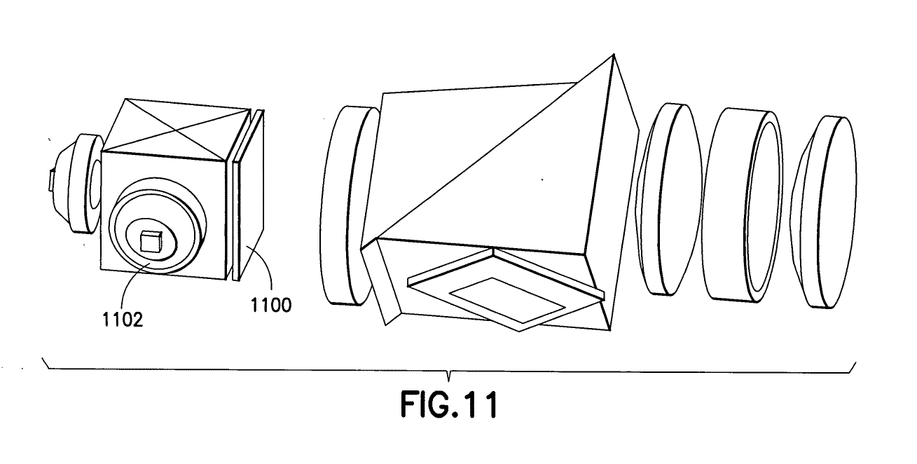

For illustrating this, FIG. 5 shows an illumination TIR-prism 500 and imaging TIR-prism 502 configuration where throughput is substantially improved by using diagonally oriented TIR-surface normals. The projections 504,506 of the normal vectors 508,510 of the TIR-surfaces 512,514 along z on the DMD array plane form 45 degree angle with the edges of the DMD array 516. The whole optical engine using this configuration is shown later in FIG. 10A and FIG. 10B. FIG. 6 shows the corresponding direction cosine presentation. As we can see, the illuminating beam 314 is fully inside the cone-curve 316, and the imaging beam 310 is fully outside of the cone-curve 316. Accordingly the TIR-surfaces do not restrict the throughput of the optical system. The throughput is limited only by the F/2.4 illumination. For example in later example we show how F/2.0 engine can be built in small and desirable form factor. F-numbers even smaller than F/2.0 can be designed according to the teachings of the invention. However in diagonal direction the F-number may be limited by the tilt angle of the micro-mirrors. Note that the cone-curve distance from the origin 308 can be adjusted by varying the refractive index (i.e. by varying the material) of the prisms 404, 410, 500, 502, and by varying the tilt angle (i.e. the angle between the vectors 400,406) of the surfaces 402, 412, 512, 514. FIG. 6 presents an embodiment where both prisms are made of the same material, and the TIR-surfaces of the both prisms are parallel. However, according to the invention, the material and surface directions can be different for the illumination TIR-prism 512 and the imaging TIR-prism 514, too. In that case the cone-curves 316,318 may be different for both of the prisms 512,514. Preferable the materials and the tilt-angle are adjusted so that the throughput limitations are minimized, for example by matching the both of the cone-curves 316,318 to cross the diagonal line 328 approximately at the point P1. Particular advantage of the invention is that the z-rotation angle of the prisms (which was 0 degrees in FIG. 4 and 45 degrees in FIG. 5) can be chosen freely from 0 to 360 degrees when optimizing the throughput of the engine, still preserving small size of the engine.

In some applications, especially when small engine thickness is the most important parameter, it may not be preferable to use the diagonally oriented TIR-prism in the configuration of the invention but some other orientation, for example the typical RTIR-orientation as was shown in FIG. 3 and FIG. 4. In that case the throughput may be limited by the cone-curves 316,318, but the double TIR-prism configuration of the invention provides still substantial advantages such as very compact and small engine size and small amount of optical components.

FIG. 1 is a generalized and simplified schematic diagram of san exemplary embodiment of the invention. For example collection and relay optical system 102 may in reality be integrated with the light source 100 or with the illumination TIR-prism 106, or with both of them. In addition to that for example the mirror 112 can be integrated with the illumination TIR-prism 106. The following figures present exemplary embodiments in a more detailed level.

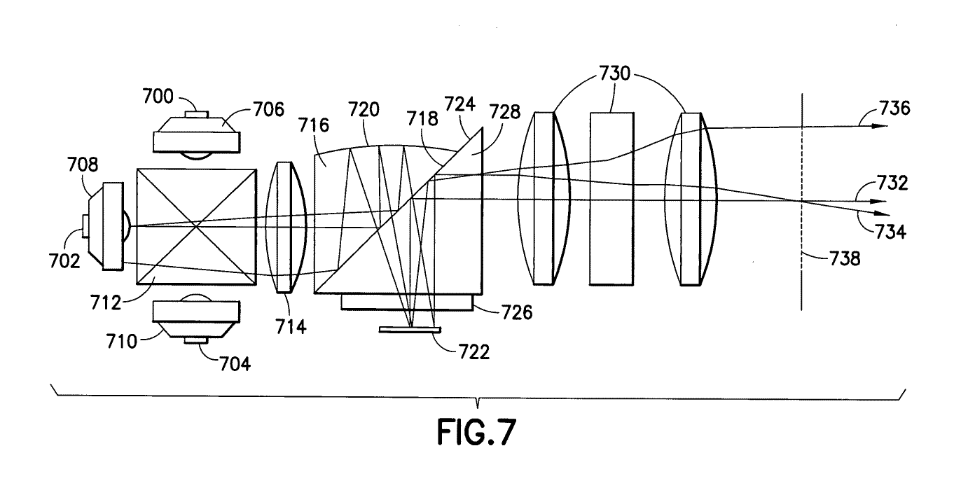

FIG. 7 shows an exemplary embodiment of the invention. Three LEDs including blue, green and red emitting LEDs 700, 702, 704 are used as light sources in field-sequential illumination. Light is collected and collimated by using illumination modules 706, 708, 710 described in U.S. patent application No. 60/837,071, filed on Aug. 10, 2006 and entitled “Illuminator Method and Device”. The illumination modules 706, 708, 710 form beams with uniform, rectangular and telecentric angular distribution, and whose circular illumination pupils are located at their output surfaces. The three beams of light are aligned with the same optical axis by using an x-cube 712. The common beam is guided through the telecentric relay lens 714 to the illumination TIR-prism 716. The beam reflects from the illumination TIR-surface 718 towards the mirror coated upper surface 720 of the illumination TIR-prism 716. So, the mirror component is 112 integrated with the illumination TIR-prism 716 by applying a mirror coating to the upper surface of the prism 720. The mirror surface 720 is cylindrically curved in this case. The illumination modules 706, 708, 710 together with the relay lens 714 and the curved mirror surface 720 work as a relay system 102 and form rectangular illumination to the micro-display 722. In this embodiment the curved mirror 720 is cylindrical because the rectangular LED chips 700, 702, 704 have different aspect ratio than the rectangular micro-display 722, so the cylindrical form adds more optical power to the other dimension and so matches the aspect ratios together. From the curved mirror surface 720 the rays are reflected through the illumination TIR-surface 718, the imaging TIR-surface 724 and DMD package cover glass 726 to the DMD-array 722. DMD-array 722 reflects light telecentric manner upwards so that the imaging TIR-prism 728 reflects the light towards the projection lens 730, which projects the image at the DMD array 722 to the screen. The optical operation is presented by the axial ray path 732, the chief ray path 734 and the marginal ray path 736, which are drawn from the illumination module 708 to the external pupil 738 of the projection lens 730.

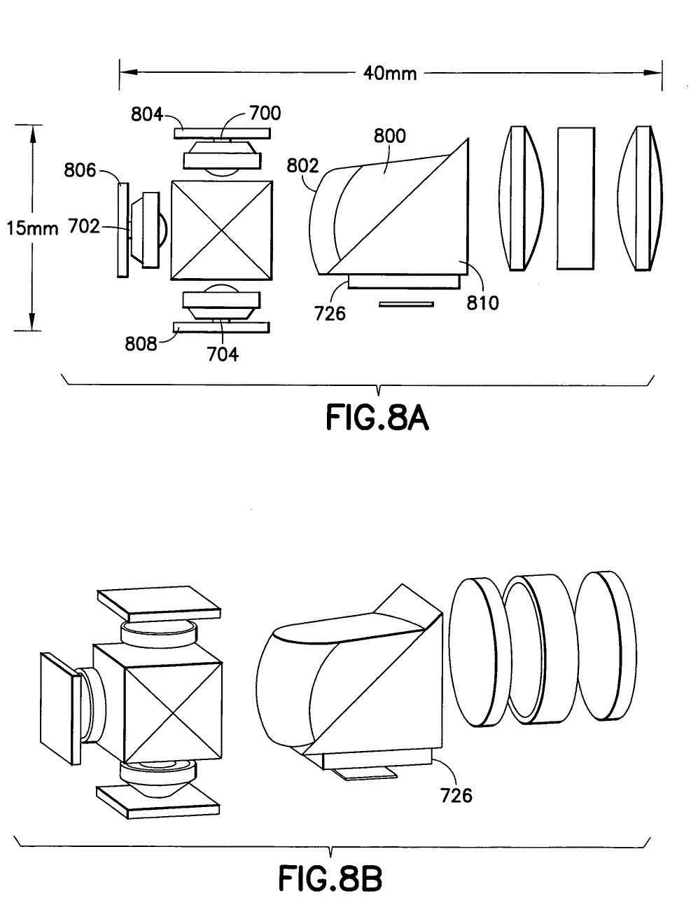

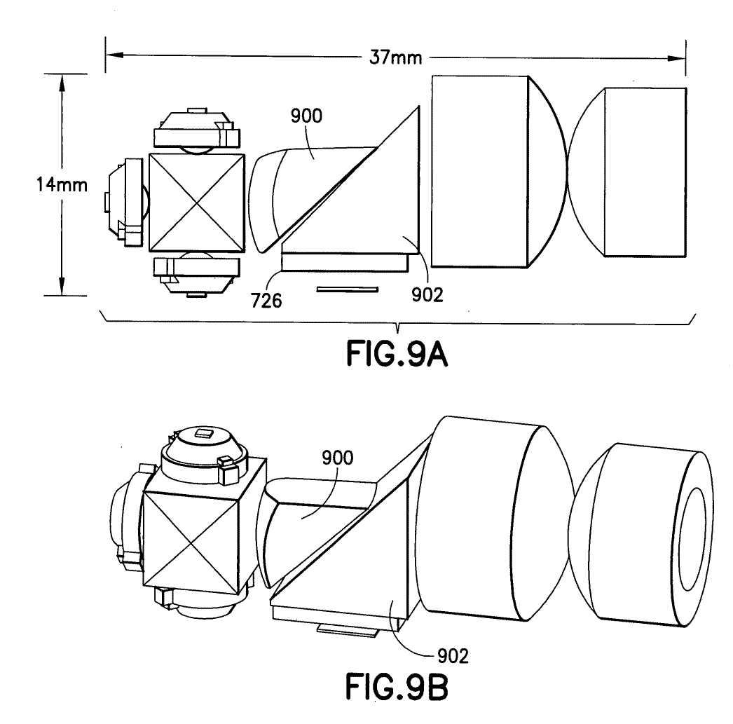

FIG. 8A shows the upper view and FIG. 8B shows a perspective view of another preferred embodiment of the invention. In principle, it is the same than the one shown in FIG. 7, apart from the relay lens 714, which in this case is integrated with the illumination TIR-prism 800. The first surface 802 of the illumination TIR-prism 800 is shaped as convex lens so that additional relay lens is not needed. The substrates 804, 806, 808, where LEDs are bonded are shown in these figures, too. The engine uses 0.7 mm×0.7 mm LED chips, and DMD panel of 3.6 mm×2.4 mm. In FIG. 8A, the full length of the optical engine is 40 mm, the width is 15 mm and the thickness 10 mm. The illumination TIR-prism 800 is made of S-TIM2 and the imaging TIR-prism 810 is made of BK7.

FIG. 9A shows the upper view and FIG. 9B shows a perspective view of still another exemplary embodiment of the invention, which is particularly small in size being 37 mm long, 14 mm width and 11 mm thick. It uses the same LEDs and DMD panel than the embodiment in FIG. 8A. The difference to FIG. 8A is that the illumination TIR-prism 900 is made of COC (cyclic olefin copolymer) plastic material instead of glass so that manufacturing is particularly inexpensive. The TIR-surface of the illumination TIR-prism is slightly tilted in respect to the TIR-surface of the imaging TIR-prism in order to match the cone-curve of the illumination TIR-prism to the cone-curve of the imaging TIR-prism.

FIG. 10A shows the upper view and FIG. 10B shows a side view of still another preferred embodiment of the invention. This configuration is optimized for high throughput and still for small size according to the previous teaching in FIG. 5 and FIG. 6. The illumination TIR-prism 1000 and imaging TIR-prism 1002, and the DMD panel 1004 are rotated so that whole F/2 illumination can be utilized. The LED chip size is 4.6 mm×2.6 mm, the DMD panel size is approximately 14 mm×11 mm and the DMD tilt angle is +/−14 degrees. Due to the rotation the optical engine design is considerable simpler than the above shown engines without the tilt. All faces of the illumination TIR-prism 1000 are planar. The top surface 1006 of the illumination TIR-prism is mirror coated. The full length of the optical engine is 116 mm, width 46 mm and thickness 46 mm. The size can be optimized smaller, too.

FIG. 11 shows a modification of the previous engine, where a tandem micro-lens array (i.e. double-sided fly's eye lens array) 1100 is used after the x-cube. Alternatively there could be such arrays between each illumination module and the x-cube. The tandem micro-lens array improves the uniformity of the illumination because instead of one chip per color four chips per color are used 1102.

According to certain exemplary embodiments of the invention, there is provided a novel optical engine configuration using a double prism arrangement for achieving large throughput in a small space and in a desirable form factor where illumination side and imaging side optical axes are substantially parallel. While the above description contains many specifics for the exemplary embodiments, these should not be construed as limitations on the scope of the invention, but as exemplifications of the presently preferred embodiments thereof. By applying the idea of the presented double-reverse TIR configuration as described here, an experienced optical designer may use optical modelling tools such as Zemax (by Zemax Development Corp., of Bellevue, Sahsington, USA), Oslo (by Sinclair Optics, Inc., Pittsford, N.Y., USA) Code V (by optical Research Associates, Pasadena, Calif., USA), etc. for finding the exact specifications of the optical configuration. Many ramifications and variations are possible within the teachings of the invention.

DMD was used as an exemplary micro-display in the examples above. Tilt angles of DMD can for example +/−10 deg, +/−12 deg or +/−14 degrees. Typical display diagonals are between 0.1 inch and 2 inch. The double prism arrangement according to the invention can also be applied with some other reflective micro-display technology such as LCoS for example with their corresponding optical engine configurations. The configuration of the invention can also be used with DMD panels where micro-mirrors are not tilted around micro-mirror diagonal but some other direction, such as around an axis parallel to some of the edges of the micro-mirror. LEDs were used as exemplary light sources in the examples above, however the invention is not limited to be used with LEDs only but the invention can be applied with other kind of light sources as well such as OLEDs, lasers, arc-lamps, UHP-lamps, etc. Instead of one led per colour, there can be several LED chips per colour for example four or six chips. Instead of three colours around x-cube there can be for example five colours which are combined to one path by using suitable dichroic mirror arrangement. Instead of one colour per illumination module, there can be for example four chips (for example one red chip, two green chips, and one blue chip) inside one illumination module, so that x-cube is not needed. The used LED chips can be surrounded by air, or they can be encapsulated with a higher refractive index material. The LED chips can be encapsulated inside silicone or epoxy dome for example.

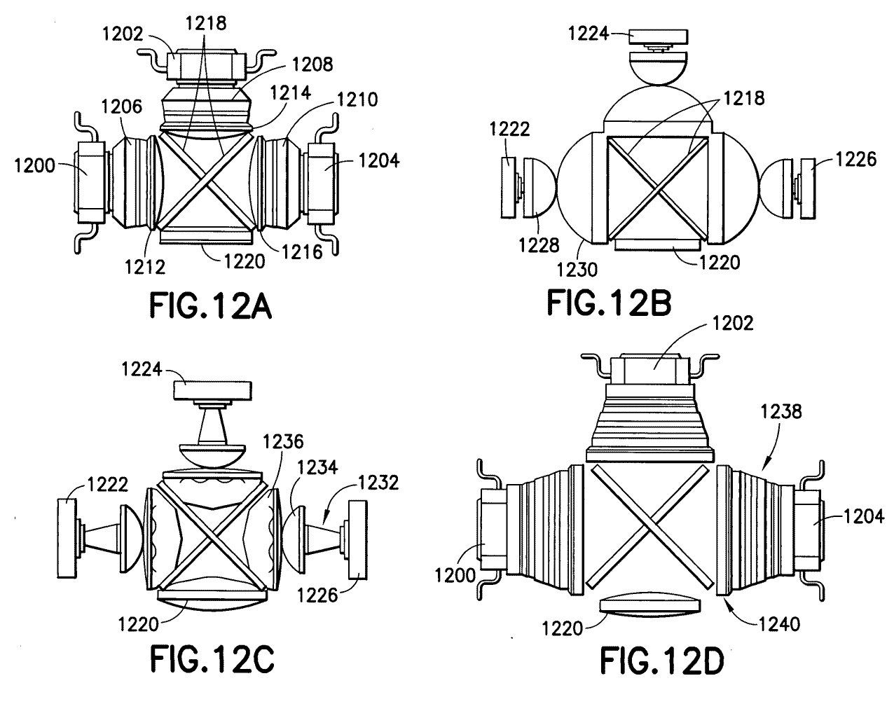

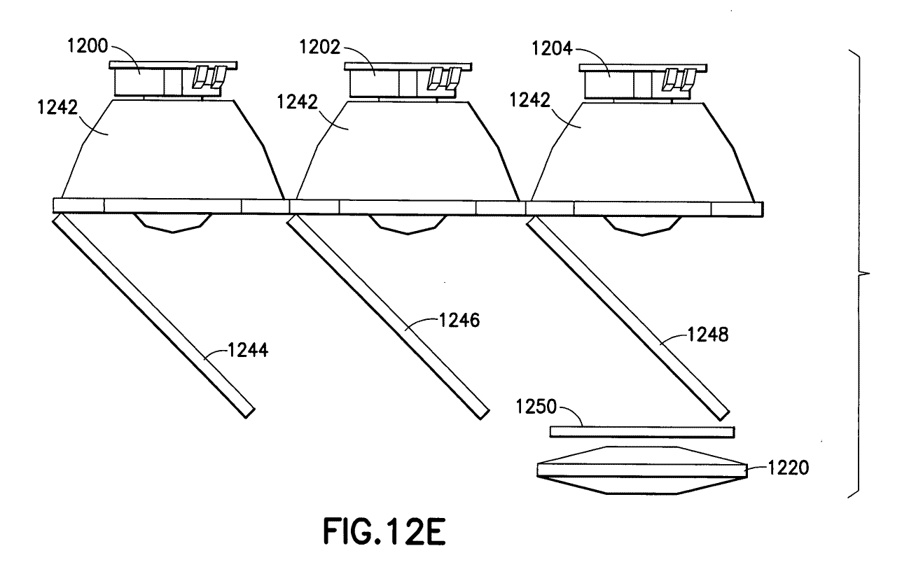

The collection and collimation optics can be implemented by various ways, too. FIG. 12A shows an collection and relay system where after collecting light from encapsulated red, green, and blue LEDs 1200, 1202, 1204 by using three illumination modules 1206, 1208, 1210, the rectangular illumination is formed by using three relay lenses 1212, 1214, 1216 before crossed dichroic plates 1218, and one relay lens 1220 after the plates. FIG. 12B shows a collection and relay system where light is collected from non-encapsulated LED chips 1222, 1224, 1226 by using two high-NA lenses 1228, 1230 per colour. FIG. 12C shows still another collection and relay system where light is collected from non-encapsulated LED chips 1222, 1224, 1226 by using a tapered light pipe 1232 and two lenses 1234, 1236. FIG. 12D shows still another collection and relay system where light is collected from encapsulated LED chips 1200, 1202, 1204 by using TIR-collimator 1238 with tandem micro-lens array 1240. FIG. 12E shows collection and relay system comprising the encapsulated LED chips 1200, 1202, 1204, three TIR-collimators 1242, a mirror 1244, two dichroics 1246, 1248, a tandem micro-lens array 1250 and a relay lens 1220.

Optical engine having high efficiency typically means that the etendue of the beam needs to be substantially preserved from the source to the projection lens. When x-cube or dichroics are used for combining beams of different spectral band, the etendue preservation needs to be calculated for one spectral band at time.

Some or all of the relay lenses can be biconic or aspherical when that improves the performance of the system. Still another form of collection and relay system comprises a collection optics with light pipe and a relay system. Typically one or more tandem micro-lens arrays (or fly's eye lens array as it may be called, too), or equivalent lens array system, can be used in most of the collection and relay systems for improving the uniformity of the beam.

Typically the collection and relay system consist of collection optics and relay optics, which in some cases can be integrated together. The collection optics collects substantially all of the light emitted from the source and forms substantially uniform and rectangular illumination to some distance, which can be basically at any distance. Infinity means that the output of the collection optics is a telecentric rectangular cone of light, which can be achieved for example by the above mentioned illumination modules or by the tandem micro-lens arrays for example. Zero distance can be achieved for example by using a light pipe or tapered light pipe. Collection optics defines an illumination pupil, which for example is at the last surface of the above mentioned illumination modules or at the last surface of the tandem micro-lens arrays, or at negative infinity when light pipe is used.

The purpose of the relay optics is to match or focus this rectangular illumination to the micro-display and at the same time to match or focus the illumination pupil to the entrance pupil of the projection lens. Matching rectangular illumination to the micro-display means that the desired area of the micro-display is substantially uniformly illuminated by the rectangular illumination. That happens when the relay optics substantially images the substantially rectangular illumination which was created by the collection optics to the micro-display plane. Matching the illumination pupil to the entrance pupil means that substantially all of the light which illuminate the micro-display and get reflected from it, can pass the aperture stop of the projection lens. That happens when the relay optics substantially images the illumination pupil to the entrance pupil of the projection lens. Typically relay optics comprises one or more lenses 714, 1212, 1214, 1216, 1220. Although in FIG. 1 the relay optics is drawn between the light source and the illumination TIR-prism, it is not limited there. The relay optics can be disposed anywhere between the collimation optics and the micro-display. The relay optics can be fully integrated with the illuminating TIR-prism such as shown in FIG. 8A, or it can be partially integrated with the illuminating TIR-prism or with the mirror component as shown in FIG. 7.

If the aspect ratio of the substantially rectangular illumination from the collection optics is different than the aspect ratio of the micro-display panel, it may be beneficial to have at least one biconic surface in the relay optical system. One solution is to use a biconic form for the mirror coated surface of the illumination TIR-prism, and use either a biconic or a non-biconic surface in the relay lens or in the first surface of the illumination TIR-prism.

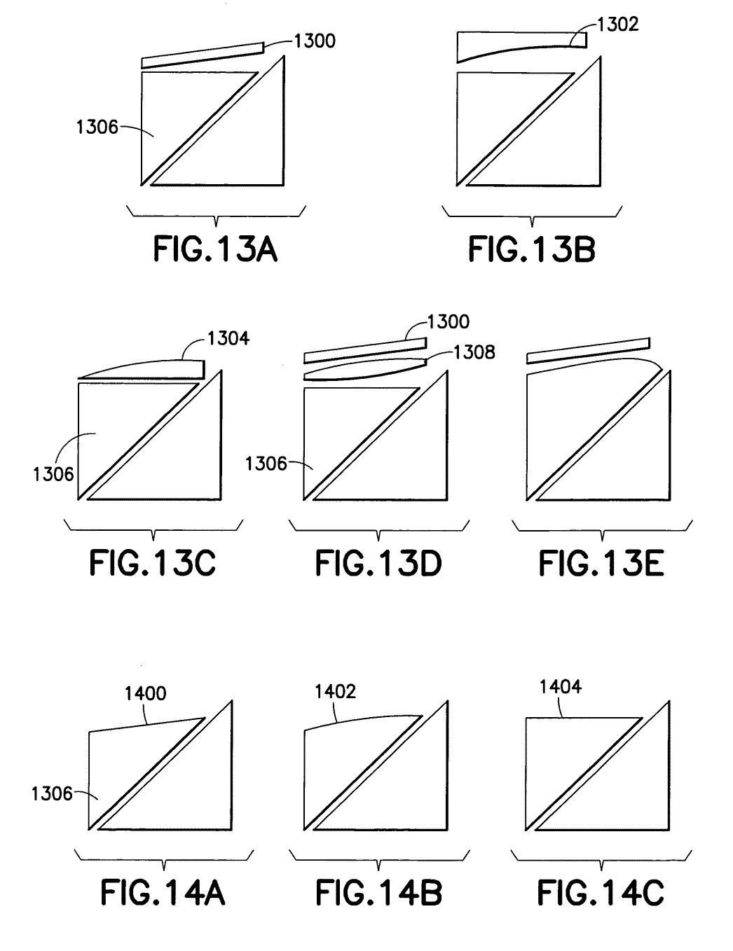

The mirror component can be implemented in different ways. It can be a planar front-surface mirror 1300 or curved (concave) front-surface mirror 1302 as shown in FIG. 13A and FIG. 13B. FIG. 13C shows a curved (convex) back-surface mirror 1304, which can be integrated with the illumination TIR-prism 1306, too. The mirror can be replaced with a lens system with a mirror coated surface. For example, the mirror itself can be planar 1300 and the needed optical power can be obtained by inserting a lens 1308 between the illuminating TIR-prism 1306 and the mirror 1300 as shown in FIG. 13D. The lens 1308 can be integrated with the illuminating TIR-prism 1306 as shown in FIG. 13E.

The mirror can be integrated with the illumination TIR-prism as shown exemplary in FIG. 14A, FIG. 14B and FIG. 14C. FIG. 14A shows a configuration where the illumination TIR-prism 1306 has a mirror coated and tilted upper surface 1400 which replaces the separate mirror component 1300. In FIG. 14B the mirror coated surface 1402 is convex curved and therefore has optical power. In FIG. 14C the mirror-coated surface 1404 consist of diffractive- or micro-optical features and therefore its orientation can be parallel with the micro-display plane for example.

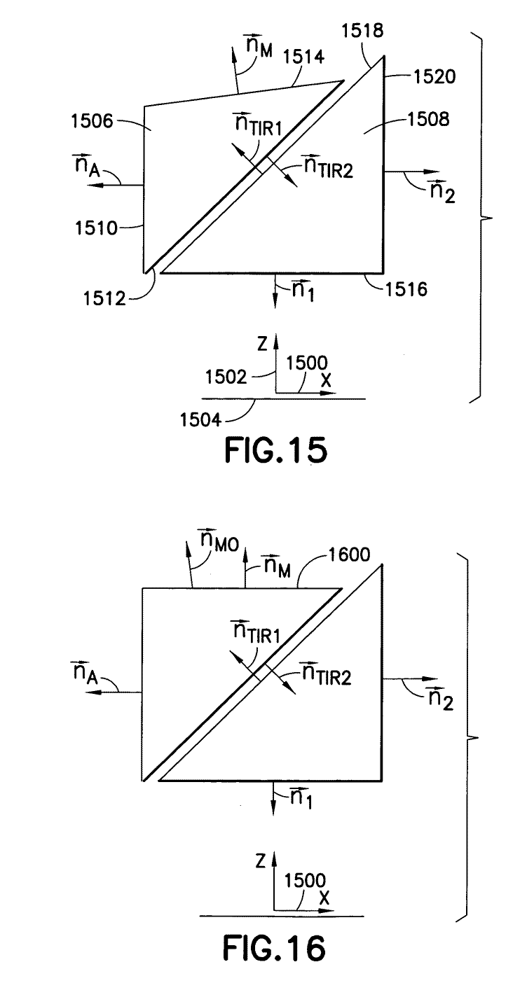

FIG. 15 shows a schematic view of an exemplary prisms arrangement of the invention. The prisms are in diagonal configuration (i.e. rotated 45 degrees around z) as it was shown in FIG. 5. The DMD active array 1500 is oriented such that its normal coincides with z-axis 1502, and its longer side coincides with x-axis 1504. The tilt angle of the DMD array is +/−14 degrees. The beam from the DMD-panel to the projection lens is supposed to be substantially telecentric. Both the illumination TIR-prism 1506 and the imaging TIR-prism 1508 are made of LAL54 glass. The surface normals of the three optical surfaces of the illuminating TIR-prism 1506 are the following:

| | |
|---|---|
| The first surface 1510 | \vec{n_{A}} = [−0.707 0.707 0] |
| TIR-surface 1512 | \vec{n_{TIR2}} = [0.5 −0.5 −0.707] |
| The second surface 1514 | \vec{n_{M}} = [−0.1 0.1 0.9898] |

The second surface 1514 is mirror coated.

The surface normals of the corresponding imaging TIR-prism 1508 can be the following:

| | |
|---|---|
| The first surface 1516 | \vec{n₁} = [0 0 −1] |
| TIR-surface 1518 | \vec{n_{TIR 2}} = [−0.5 0.5 0.707] |
| The second surface 1520 | \vec{n₂} = [0.707 −0.707 0] |

Suppose otherwise similar prism configuration but with +/−12 degree DMD tilt angle, and with non-rotated prisms (i.e. prisms not rotated 45 degrees around z). Another possible configuration of the prisms is the following: The illumination TIR-prism 1506:

| | |
|---|---|
| The first surface 1510 | \vec{n_{A}} = [−1 0 0] |
| TIR-surface 1512 | \vec{n_{TIR2}} = [0.707 0 −0.707] |
| The second surface 1514 | \vec{n_{M}} = [−0.097124 0.097124 0.99052] |

And the corresponding imaging TIR-prism 1508:

| | |
|---|---|
| The first surface 1516 | \vec{n₁} = [0 0 −1] |
| TIR-surface 1518 | \vec{n_{TIR2}} = [−0.707 0 0.707] |
| The second surface 1520 | \vec{n₂} = [1 0 0] |

Consider again the prism configuration of FIG. 15. The planar mirror coated second surface 1514 of the illumination TIR-prism 1506 can be replaced with micro-optical surface such that it has substantially the same function. That is illustrated in FIG. 16. The micro-optical surface 1600 can be planar in macroscopic level and have normal \vec{n_{M}}=[0 0 1] and it can be reflective having local surface normal of \vec{n_{M0}}=[−0.097124 0.097124 0.99052].

All surfaces of the illumination TIR-prism can have optical power either by curved form or by suitable micro-optical features. When any optical surface between the collimation optics and the micro-display has optical power, it can be interpreted to be integrated with the relay optics. Optical surface is defined as being such an area of any surface, which transmits, reflects, or diffracts such rays which are finally reflected from the micro-display and projected through the projection lens. If an optical surface is not planar, or if an optical surface comprises diffractive- or micro-optical features, it is said to have optical power.

The material of both of the prisms can be chosen from the wide selection of available optical materials. Possible materials are for example BK7, S-TIM2, SF2, SF11, SF57, PBH56, S-LAL54 for example. Optical plastic materials such as polycarbonate, PMMA (poly methyl methacylate), COC, polystyrene for example may be a feasible choice, too. The illumination TIR-prism can be different material than imaging side TIR-prism. When the illumination TIR-prism has curved surfaces, plastic material may be preferable for manufacturing point of view.

The beam from the micro-display to the projection lens is preferably telecentric but it can be non-telecentric, too. The illuminating and imaging beams are typically at least slightly non-telecentric. It needs to be noted that the double prism configuration of embodiments of the invention is not limited to be used only with telecentric illumination arrangements but it can be used with fully non-telecentric systems, too.

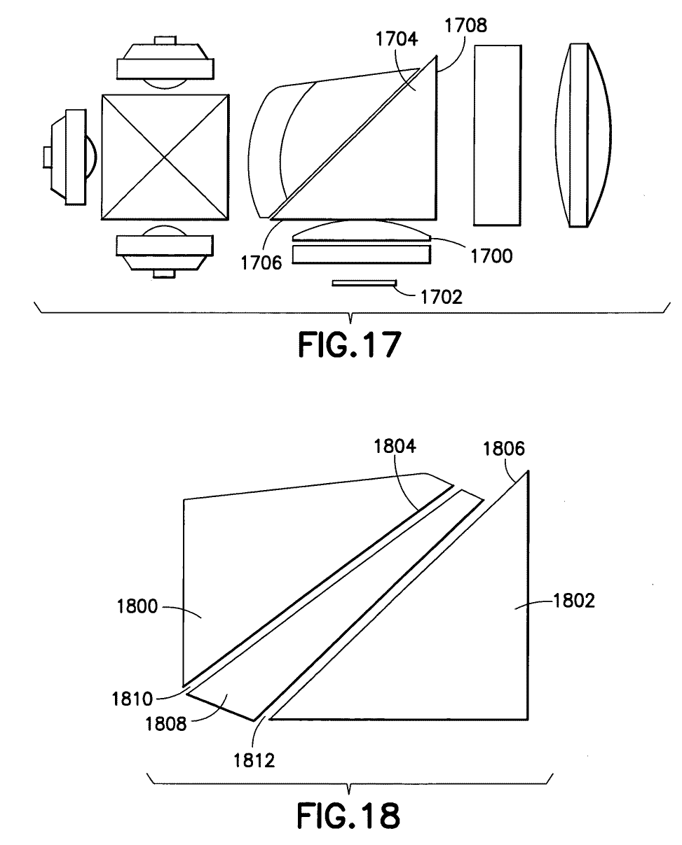

FIG. 17 shows a configuration where a field lens 1700 is used between the micro-display 1702 and the imaging TIR-prism 1704. The field lens can be integrated with the imaging TIR-prism, so that the first surface 1706 or the second surface 1708 of the imaging TIR-prism has optical power. The use of the field lens enables a smaller total length of the optical engine.

The TIR-surfaces of the illumination and imaging TIR-prisms need not to be co-planar. For example in many configurations it is advantageous to tilt the illumination TIR-prism 1800 as shown in the FIG. 18. Particularly in the case that the prisms have different indices of refraction, their corresponding cone-curves 316,318 as described with FIG. 3 will be different. In order to match the curves in the best possible way for minimizing the etendue degradation, it may be beneficial to tilt the illumination TIR-prism 1800 with respect to the imaging TIR-prism 1802. The TIR-surfaces 1804, 1806 of both the illumination TIR-prism and imaging TIR-prism may have optical power, too. There can be an optical element 1808 between the illumination and imaging TIR-prisms, too. In order to avoid the beam expanding too much in the gap between the prisms 1800, 1802, another prism 1808 is inserted for filling the gap. Naturally in order to obtain the TIR-reflections there need to be small air gaps 1810, 1812 between both of the TIR-surfaces 1808, 1806 and the added prism 1808.

Various embodiments may include one or any combination of the following novel features:
The use of two TIR-prisms (one for TIR-reflection in illumination side and one for TIR-reflection in imaging side) such that illumination and imaging axis become substantially parallel and the optical engine shrinks to a compact form factor.
The double use of the same air gap in order to achieve the same.
The use of micro-optics in the mirror coated surface of the illuminating TIR prism in order to get the uppermost surface of the illuminating TIR prism parallel to the micro-display plane
The use of curved surfaces in the illumination TIR-prism for integrating the relay optical system fully or partially to the prism
The use of curved surfaces in the imaging TIR-prism for integrating a part of the relay optical system to the prism and for integrating a part of the projection lens to the prism

### Building and Testing.

The system of FIG. 1 was tested using Zemax optical design software. Several different designs were built by using a sequential model, and the performance was tested by using the non-sequential model.

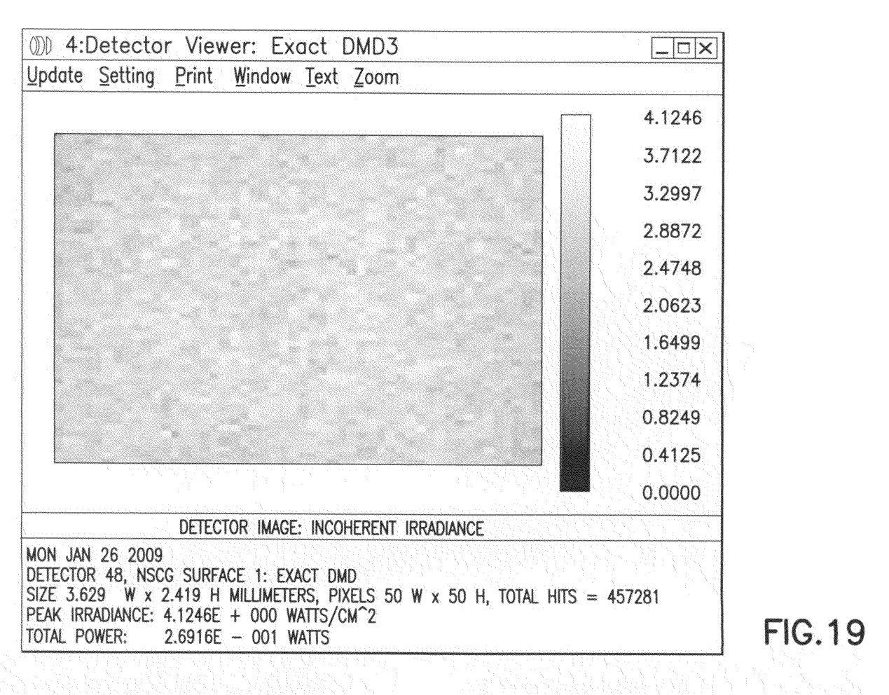

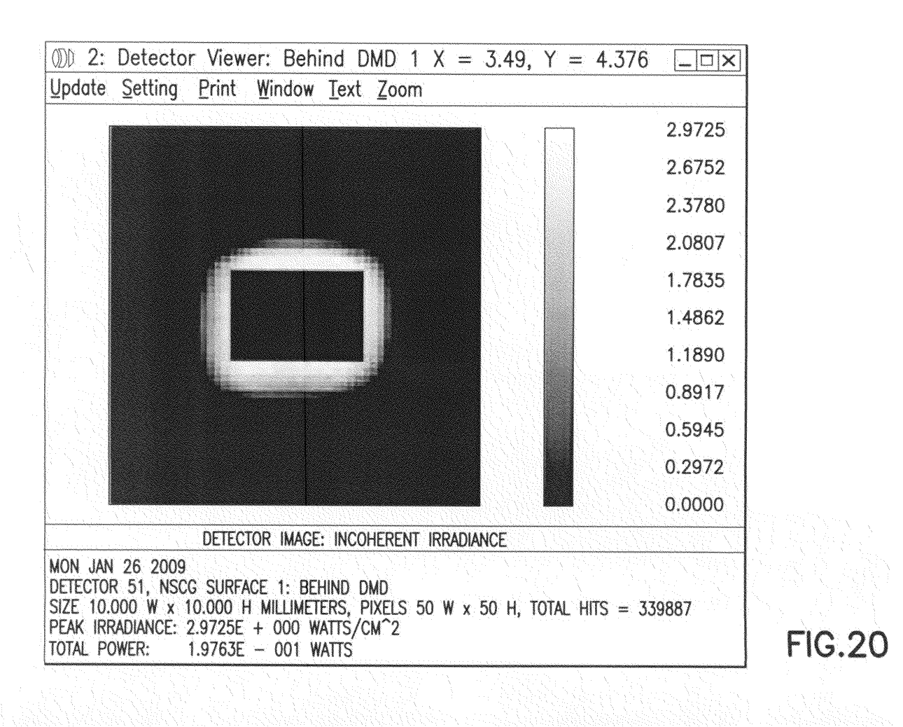

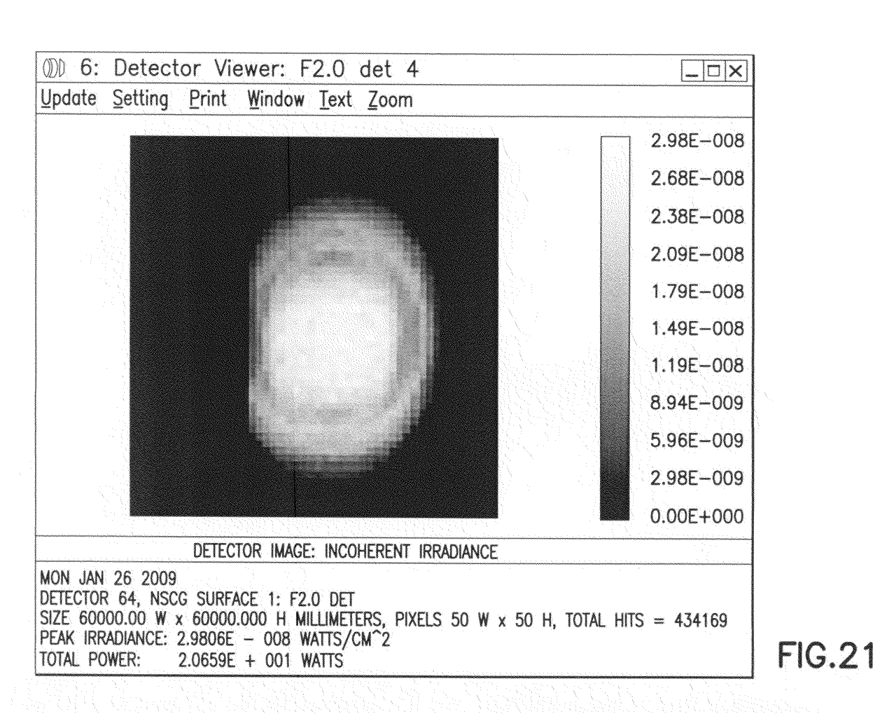

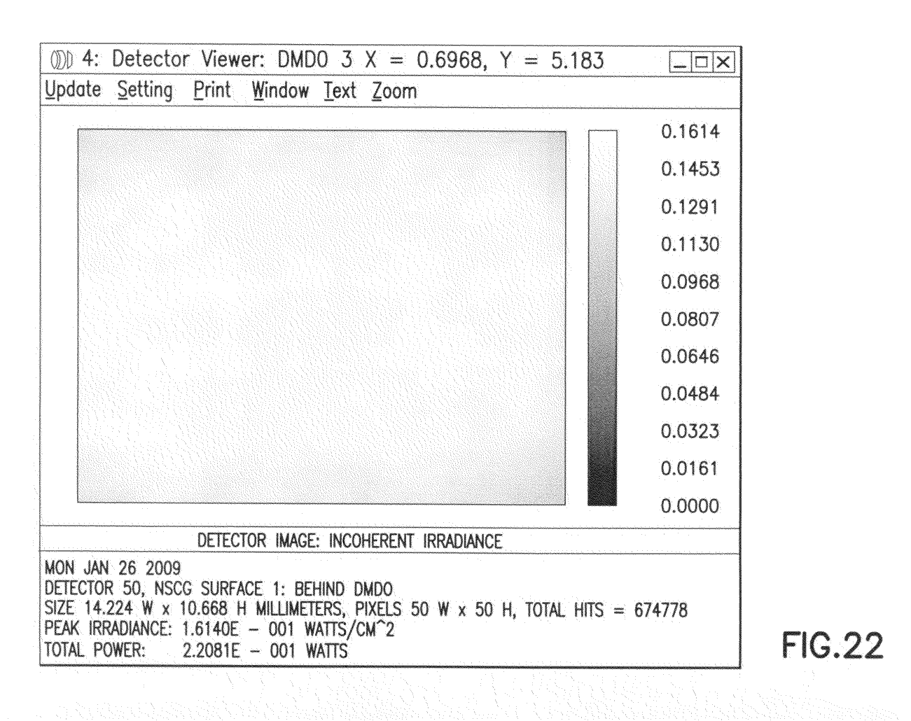

The operation of the Zemax models was according to the inventors' expectations and showed that the presented double reverse TIR configuration really works. FIG. 19, FIG. 20 and FIG. 21 show the simulation results of the configuration shown in FIG. 8A. FIG. 19 shows the illumination at the DMD-panel after ray tracing with 900 000 rays. 50.8% of the rays emitted by the LED are arriving to the active panel area. FIG. 20 shows the illumination around the DMD-panel. 37.8% of rays are absorbed around the active area. FIG. 21 shows the beam cross-section after the projection lens F/2 entrance pupil. 48.2% of the emitted rays are passing F/2.0 aperture.

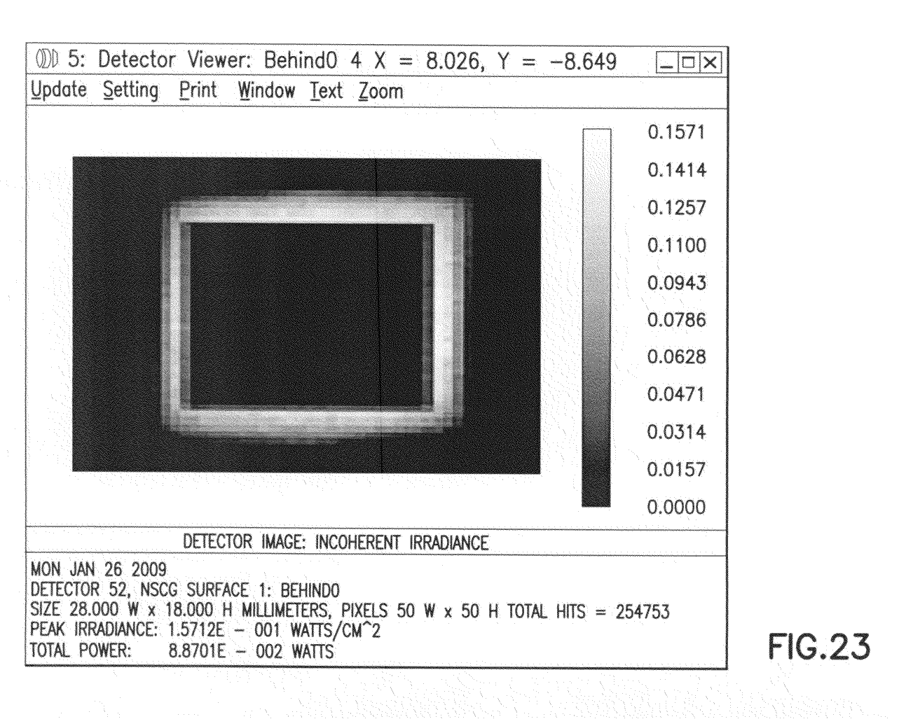

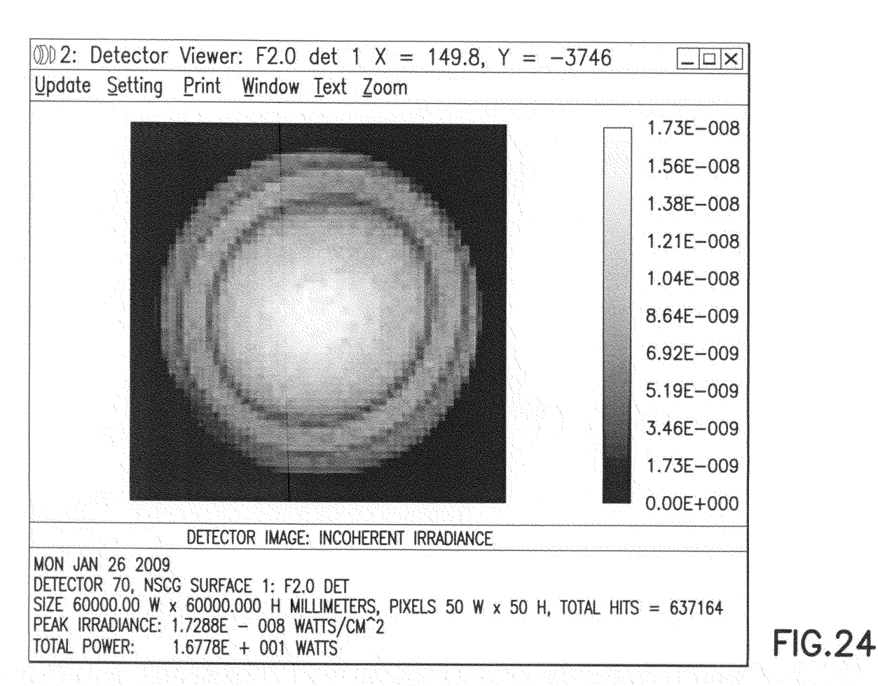

FIG. 22, FIG. 23 and FIG. 24 shows the corresponding results for the configuration shown in FIG. 10A after ray tracing with one million rays. 67.5% of the rays are reflecting from the DMD-panel, 25.5% rays are absorbed next to the panel, and 63.7% of the rays are passing the F/2 projection lens.

The achievable absolute ray efficiencies naturally depend on many different factors, for example the source etendue in respect to the DMD-panel area and projection lens F-number. However, the purpose of efficient projection engines is to use substantially all rays what are available, for projection purpose. In some configurations it may mean 90% of all emitted light. In some other configurations for example 30% of all emitted light is substantially all light, taking account the limiting factors.

Although described in the context of particular embodiments, it will be apparent to those skilled in the art that a number of modifications and various changes to these teachings may occur. Thus, while the invention has been particularly shown and described with respect to one or more embodiments thereof, it will be understood by those skilled in the art that certain modifications or changes may be made therein without departing from the scope of the invention as set forth above.

We claim:

1. A device for a light projection system, the device comprising:
at least one light source;
light collection and relay optics;
a reflective surface;
a micro-display;
an illumination total internal reflection TIR-prism disposed between the reflective surface and the micro-display;
an imaging TIR-prism disposed between the illumination TIR-prism and the micro-display; and
a projection lens,
wherein the light collection and relay optics is arranged to channel light emitted by the at least one light source to the illumination TIR-prism;
the TIR-prism is arranged to totally internally reflect the light to the reflective surface;
the reflective surface is arranged to reflect the light back through the illumination TIR-prism and through the imaging TIR-prism to the micro-display;
the micro-display is arranged to reflect the light back through the imaging TIR-prism; and
the imaging TIR-prism is arranged to totally internally reflect the light from the micro-display to the projection lens.

2. The device of claim 1, wherein the light source comprises at least one green light emitting diode LED chip, at least one blue LED chip and at least one red LED chip.

3. The device of claim 1, where the light collection and relay optics is configured to collect substantially all light emitted by the at least one light source and to form a substantially uniform and substantially rectangular illumination.

4. The device of claim 3, wherein collection optics of the light collection and relay optics is configured to substantially preserve etendue of a beam from the at least one light source that is channeled to the illumination TIR-prism.

5. The device of claim 3, wherein relay optics of the light collection and relay optics is arranged to output substantially uniform and rectangular illumination which substantially matches with the micro-display.

6. The device of claim 5, wherein the matching substantially preserves etendue of a beam which comprises the light.

7. The device of claim 5, wherein the relay optics is arranged to match an illumination pupil with an entrance pupil of the projection lens.

8. The device of claim 1, wherein the light collection and relay optics comprises at least one spherical or aspherical surface.

9. The device of claim 1, wherein the micro-display comprises digital micro-mirror device.

10. The device of claim 9, wherein surface normals of TIR-surfaces of the illuminating TIR-prism and of the imaging TIR-prism are perpendicular to a tilt axis of micro-mirrors of the micro-mirror device.

11. The device of claim 9, wherein material and orientation of the TIR-surfaces of the illumination and imaging TIR-prisms are particularly adapted to match cone-curves with the tilt-angle of the micro-mirrors.

12. The device of claim 1, wherein the reflective surface comprises a mirror coated surface which is a part of the light collection and relay optics system by having optical power.

13. The device of claim 1, wherein the illumination TIR-prism comprises at least one surface which is a part of the light collection and relay optics by having optical power.

14. The device of claim 1, wherein the reflective surface is integrated with the illumination TIR-prism.

15. The device of claim 14, wherein a first surface of the illumination TIR-prism and the reflective surface of the illumination TIR-prism have aspherical biconic forms and a TIR-surface of the illumination TIR-prism is planar.

16. The device of claim 1, wherein all optical faces of the illumination TIR-prism are planar.

17. The device of claim 1, wherein at least one optical surface of the illumination TIR-prism has optical power.

18. The device of claim 1, wherein the illumination TIR-prism is separated by an air gap from the imaging TIR-prism.

19. The device of claim 1, further comprising a convex field lens disposed between the micro-display and the imaging TIR-prism, the field lens adapted to operate as a part of both the light collection and relay optics and as a part of the projection lens.

20. The device of claim 19, wherein the field lens is integrated with the imaging TIR-prism.

21. The device of claim 1, wherein the light collection and relay optics comprises at least one of fly's eye lens array, a light pipe, an imaging lens, and a high numerical aperture lens.

22. The device of claim 1, wherein an optical axis of the device is parallel as between an input to the illumination TIR-prism where the light enters from the at least one light source and an output of the imaging TIR-prism where the light is directed toward the projection lens.

23. The device of claim 22, wherein the optical axis from the output of the imaging TIR-prism through the projection lens is a straight line.

24. The device of claim 1, wherein the device is arranged such that a beam of the light reflected from the micro-display toward the imaging TIR-prism is substantially telecentric.

25. The device of claim 1, wherein:
the illumination TIR-prism is arranged to reflect the light from the at least one light source at an angle of approximately ninety degrees toward the reflective surface;
the imaging TIR-prism is arranged to reflect the light from the micro-display at an angle of approximately ninety degrees toward the projection lens;
and each of the reflective surface and the micro-display are arranged to reflect the light at an angle of approximately one hundred and eighty degrees.
